(19) United States
(12) Patent Application Publication
(10) Pub. No.: US 2019/0097442 A1
(43) Pub. Date: Mar. 28, 2019

(54) CHARGING TERMINAL SYSTEM

(71) Applicant: Aaron Richards Rasor, Fort Worth, TX (US)

(72) Inventor: Aaron Richards Rasor, Fort Worth, TX (US)

(21) Appl. No.: 16/146,869

(22) Filed: Sep. 28, 2018

Related U.S. Application Data
(60) Provisional application No. 62/564,398, filed on Sep. 28, 2017.

(51) Int. Cl. H02J 7/00; H02J 7/02

(52) U.S. Cl. CPC H02J 7/0042; H02J 7/025

(57) ABSTRACT

A charging terminal system creates a permanent fixture where battery powered devices can receive electricity. The system encases a transmission apparatus such as by induction in a protective cover. The cover also has personalization features to present the system as more than charger but a piece of memorabilia or similar items.

### BACKGROUND

### 1. Field of the Invention

The present invention relates generally to battery charging systems, and more specifically, to a charging terminal system for simplifying the transfer of electricity to a battery on a repetitive basis.

### 2. Description of Related Art

Battery charging systems are well known in the art and are effective means to replace the electric capacity of a device. For example, FIG. 1 depicts a conventional battery charger system 101 having a battery 103, an outlet 105 and a cable 107. During use, the battery 103 is placed in electrical communication with the outlet 105 via cable 107 until the capacity of the battery 103 is filled.

One of the problems commonly associated with system 101 is it limited use. For example, the capacity of the battery 103 is used in a few hours to a few days resulting in the frequent charging of the battery 103. The repeated use causes physical wear on the cable 107 and battery 103.

In addition, the frequent charging results in the cable 107 being left in or near the outlet 105 creating clutter and safety hazard.

Accordingly, although great strides have been made in the area of battery charger systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common battery charger system;

FIG. 2 is a top view of a charging terminal system in accordance with a preferred embodiment of the present application; and

FIG. 3 is a cross-sectional side view of the pad of FIG. 2;

FIG. 4 is a side view of an alternative embodiment of the cover of FIG. 2; and

FIG. 5 is a flowchart of the preferred method of us of the system of FIG. 2.

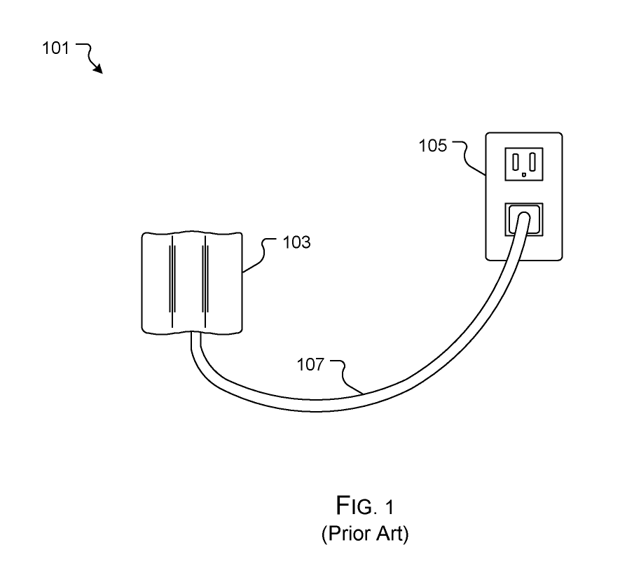

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional battery charger systems. Specifically, the system of the present invention reduces the physical damage incurred during the charging process. In addition, by making the terminal a permanent fixture the clutter and safety risks are mitigated. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

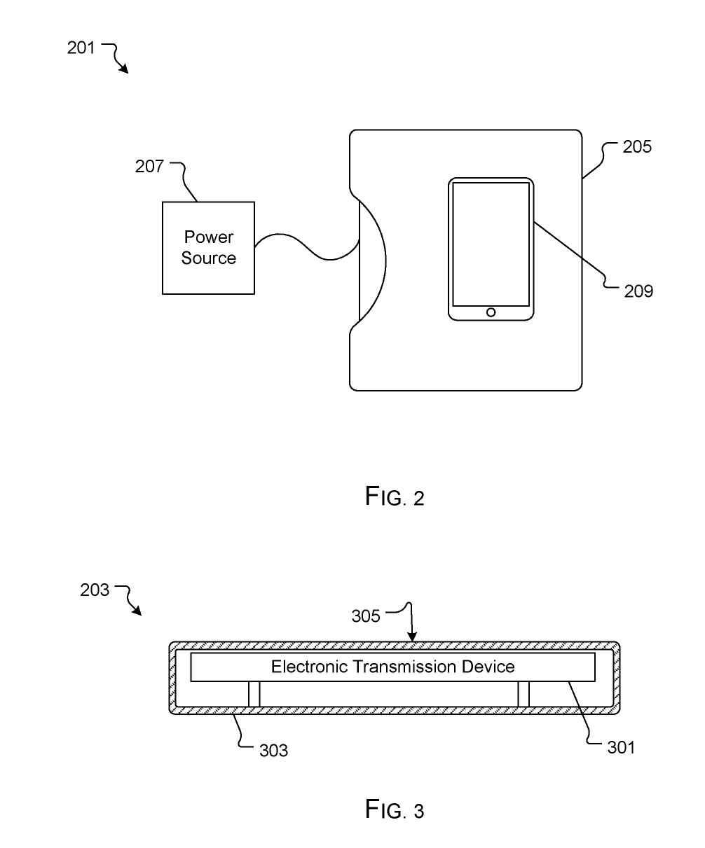

Referring now to the drawings wherein like reference characters identify corresponding or similar elements throughout the several views, FIG. 2 depicts a top view of a charging terminal system in accordance with a preferred embodiment of the present application. It will be appreciated that system 201 overcomes one of more of the above-listed problems commonly associated with conventional battery charger devices.

In the contemplated embodiment, system 201 includes a pad 203 enclosed by a cover 205. The pad 203 being in electrical communication with a power source 207. In use, a battery powered device 209 is placed on the cover 205 and receives electricity from the pad 203.

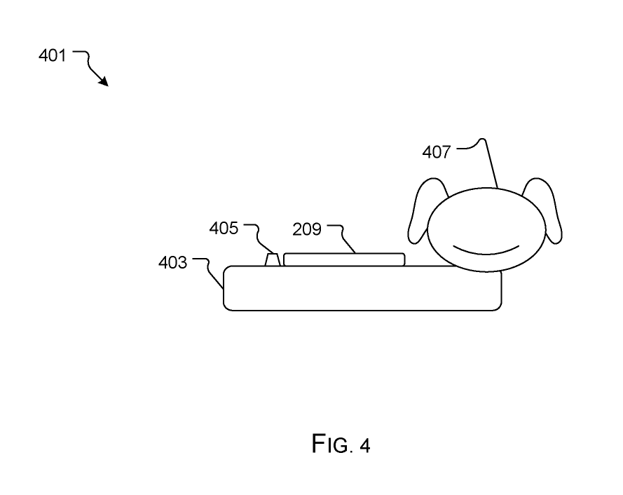

Referring now to FIG. 3 the pad 203 is depicted. Pad 203 having an electronic transmission apparatus 301 is housed within a body 303. The transmission apparatus being positioned to emit electricity over the entire area of the top surface 305. The transmission apparatus 301 being configured to conduct electricity to a battery without the use of cables or wiring.

It should be appreciated that one of the unique features believed characteristic of the present application is cover 205 that prevents physical damage to the pad 203 and device 209. It will also be appreciated that pad 203 and cover 205 provide a stable fixture that is located in once place preventing trip hazards and does not appear as clutter or out of place.

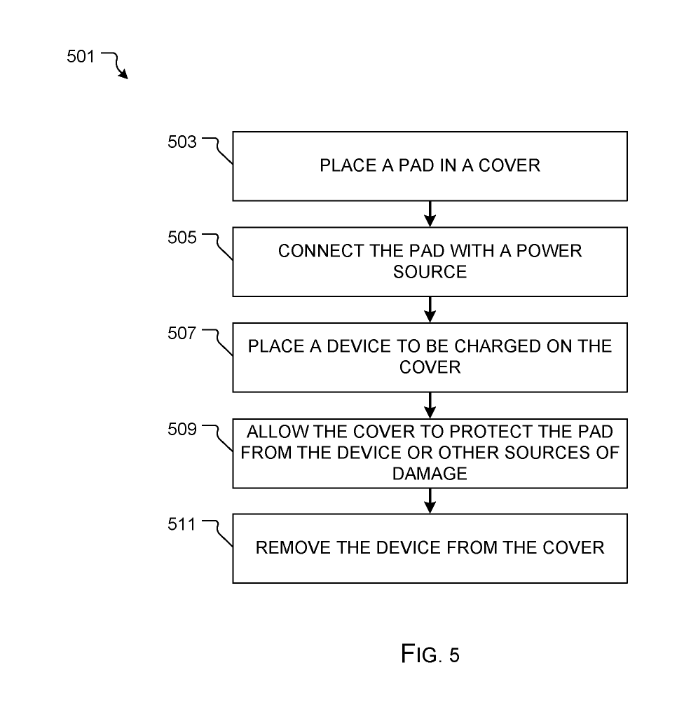

Referring now to FIG. 4 an alternative embodiment of the cover 205 is depicted. Embodiment 401 including a protective body 403 having a support 405 attached. The support being configured to alter the position of the battery powered device 209 with respect to the pad 203. The body 403 also having personalization features attached 407. It is contemplated that personalization features further distinguish the system 201 from being clutter or out of place to being part of the ambiance of the location in which it is used. It is also contemplated that the support 405 could be movable to allow facilitate positioning the device 209 as well as to secure the device 209 to the cover 205, 401.

Referring now to FIG. 5 a method of protecting a charging pad with the system 201. Method 501 includes placing a pad in a cover 503, connecting the pad with a power source 505, placing a device to be charged on the pad 507, allowing the cover to prevent damage from occurring to the pad while transferring a charge to the device 509 and removing the device from the cover 511.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A charging terminal system comprising:
a pad enclosed within a cover; and
a batter powered device;
wherein the pad is electrical communication with a power source;
wherein the cover prevents damage to the pad; and
wherein the pad transfers electricity to the battery powered device.

2. The system of claim 1 wherein the cover comprises a protective body and at least one personalization feature attached thereto.

3. The system of claim 1 wherein the cover comprises a support member to alter the orientation of the battery powered device with respect to the pad.

4. The method of preventing damage to a charging pad given the system of claim 1, comprising:
placing a pad in a cover;
connecting the pad with a power source;
placing a device to be charged on the pad
allowing the cover to prevent damage from occurring to the pad while transferring a charge to the device; and
removing the device from the cover.
